(19) United States
(12) Patent Application Publication
(10) Pub. No.: US 2019/0304082 A1
(43) Pub. Date: Oct. 3, 2019

(54) IMAGE INSPECTION APPARATUS AND IMAGE INSPECTION SYSTEM

(71) Applicant: PANASONIC INDUSTRIAL DEVICES SUNX CO., LTD., Aichi (JP)

(72) Inventors: Kiyoshi TOKASHIKI, Aichi (JP); Shohei ISHII, Gifu (JP); Koji SHIINA, Aichi (JP); Yumi ONO, Aichi (JP); Naoaki NODA, Aichi (JP); Hidenori SHIRAI, Aichi (JP)

(21) Appl. No.: 16/284,137

(22) Filed: Feb. 25, 2019

(30) Foreign Application Priority Data
Mar. 29, 2018 (JP) 2018-066249

(51) Int. Cl. G06T 7/00; H04L 29/06; H04L 29/08

(52) U.S. Cl. CPC G06T 7/0004; H04L 63/083; G06T 2207/30164; H04L 67/02; H04L 63/101

(57) ABSTRACT

An image inspection apparatus includes: an imaging unit configured to capture an image of an inspection target; a control unit configured to process the captured image and execute predetermined image inspection; and a communication unit configured to communicate with a terminal about information input to and output from the control unit. The communication unit is capable of performing communication using a general-purpose protocol. The control unit has a web server function, acquires authentication information transmitted from the terminal to authenticate a user or a terminal based on the authentication information, receives an access request for a monitor screen regarding the image inspection from the terminal using the general-purpose protocol, generates a web content of a monitor screen corresponding to the authenticated user or terminal, and transmits the generated web content to the terminal.

### CROSS-REFERENCES TO RELATED APPLICATIONS

This application is based on and claims priority from Japanese Patent Application No. 2018-066249 filed on Mar. 29, 2018, the entire contents of which are incorporated herein by reference.

### FIELD

One or more embodiments of the present invention relate to an image inspection apparatus and an image inspection system for executing image processing and inspection of a captured image as inspection such as determination of quality of products in a production process in a production facility such as a factory.

### BACKGROUND

In recent years, a large number of image inspection systems capable of accurately, quickly and automatically performing various visual inspections depending on human vision have been introduced to production facilities such as factories. For example, JP-A-2003-076978 discloses an image processing inspection system configured such that an image processing inspection apparatus and a computer are connected to each other to allow bidirectional communication therebetween through a communication interface.

In the above-described image inspection system, the image processing inspection apparatus includes first display means and first input means and executes various inspection measurements for an inspection target through image processing performed on an image obtained by imaging, under inspection conditions set by using the first input means. The computer includes second display means and second input means and displays inspection measurement results obtained from the image processing inspection apparatus on the second display means. According to such an image processing inspection system, it is possible to set inspection conditions required for inspection measurement while monitoring the state of an inspection target by a moving image on the computer side.

### SUMMARY

In the above-described image inspection system, an image inspection apparatus and each device such as a computer are connected to each other through a communication interface using a monitor and software designed exclusively for the image inspection system. In this case, it is necessary to perform camera setting and inspection image monitoring by using the dedicated monitor and the dedicated software, which results an increase in introduction cost of the system. It is difficult to perform camera imaging setting, setting such as image inspection items and parameters, or monitoring of an inspection image at a user's desired location such as a movement destination or a remote place. For this reason, there is a problem in that it is not possible to execute image inspection flexibly corresponding to a usage environment of a user, a terminal used by the user, or usage conditions such as the user's demands.

One or more embodiments of the present invention have been made in view of the above-described circumstances, and an object thereof is to provide an image inspection apparatus and an image inspection system capable of monitoring and setting of an inspection image according to usage conditions without using a dedicated monitor and dedicated software.

One or more embodiments of the present invention provide an image inspection apparatus including: an imaging unit configured to capture an image of an inspection target; a control unit configured to process the captured image of the inspection target and execute predetermined image inspection; and a communication unit configured to communicate with a terminal about information that is input to and output from the control unit, wherein the communication unit is capable of performing communication using a general-purpose protocol, and wherein the control unit has a web server function of distributing a web content in response to an access request from a terminal connected to the apparatus, acquires authentication information transmitted from the terminal to authenticate a user or a terminal based on the authentication information, receives an access request for a monitor screen regarding the image inspection from the terminal using the general-purpose protocol, generates a web content of a monitor screen corresponding to the authenticated user or terminal, and transmits the generated web content to the terminal.

One or more embodiments of the present invention provide an image inspection system including: an image inspection apparatus configured to capture an image of an inspection target and execute image processing and predetermined image inspection of the captured image; and a terminal that is connected to the image inspection apparatus through a communication interface, wherein the image inspection apparatus includes: an imaging unit configured to capture the image of the inspection target; a control unit configured to process the captured image of the inspection target and execute the predetermined image inspection; and a communication unit configured to communicate with a terminal about information that is input to and output from the control unit, wherein the communication unit is capable of performing communication using a general-purpose protocol, wherein the control unit has a web server function of distributing a web content in response to an access request from the terminal, acquires authentication information transmitted from the terminal to authenticate a user or a terminal based on the authentication information, receives an access request for a monitor screen regarding the image inspection from the terminal using the general-purpose protocol, generates a web content of a monitor screen corresponding to the authenticated user or terminal, and transmits the generated web content to the terminal, wherein the terminal includes a display device and a processing unit having a browser function for displaying the web content distributed from the image inspection apparatus, and wherein the terminal transmits the authentication information to the image inspection apparatus, receives the web content of the monitor screen distributed to the terminal based on the authentication information, and displays the monitor screen regarding the image inspection on the display device.

According to one or more embodiments of the present invention, it is possible to perform monitoring and setting of an inspection image according to usage conditions without using a dedicated monitor and dedicated software.

### BRIEF DESCRIPTION OF DRAWINGS

FIG. 1 is a diagram illustrating a configuration example of an image inspection system according to the present embodiment;

FIG. 2 is a block diagram illustrating a configuration example of an image inspection apparatus according to the present embodiment;

FIG. 3 is a perspective view illustrating an example of an exterior configuration of the image inspection apparatus according to the present embodiment;

FIG. 4 is a bottom view illustrating an example of an exterior configuration of the image inspection apparatus according to the present embodiment;

FIG. 5 is a block diagram illustrating a first example of a connection configuration of the image inspection system according to the present embodiment;

FIG. 6 is a diagram illustrating a first example of an inspection image screen in the image inspection system according to the present embodiment;

FIG. 7 is a diagram illustrating an example of an inspection setting screen in the image inspection system according to the present embodiment;

FIG. 8 is a diagram illustrating an example of a system setting screen in the image inspection system according to the present embodiment;

FIG. 9 is a diagram illustrating a second example of an inspection image screen in the image inspection system according to the present embodiment; and

FIG. 10 is a block diagram illustrating a second example of the connection configuration of the image inspection system according to the present embodiment.

### DETAILED DESCRIPTION

Hereinafter, embodiments specifically disclosing an image inspection apparatus and an image inspection system will be described in detail with reference to the accompanying drawings as appropriate.

In the present embodiment, as the image inspection apparatus and the image inspection system, description will be given of an example of a configuration in which image inspection of a target or the like in a production line is performed in a production facility controlled by a programmable logic controller (PLC) provided in, for example, a factory or the like.

### Configuration Example of Image Inspection System

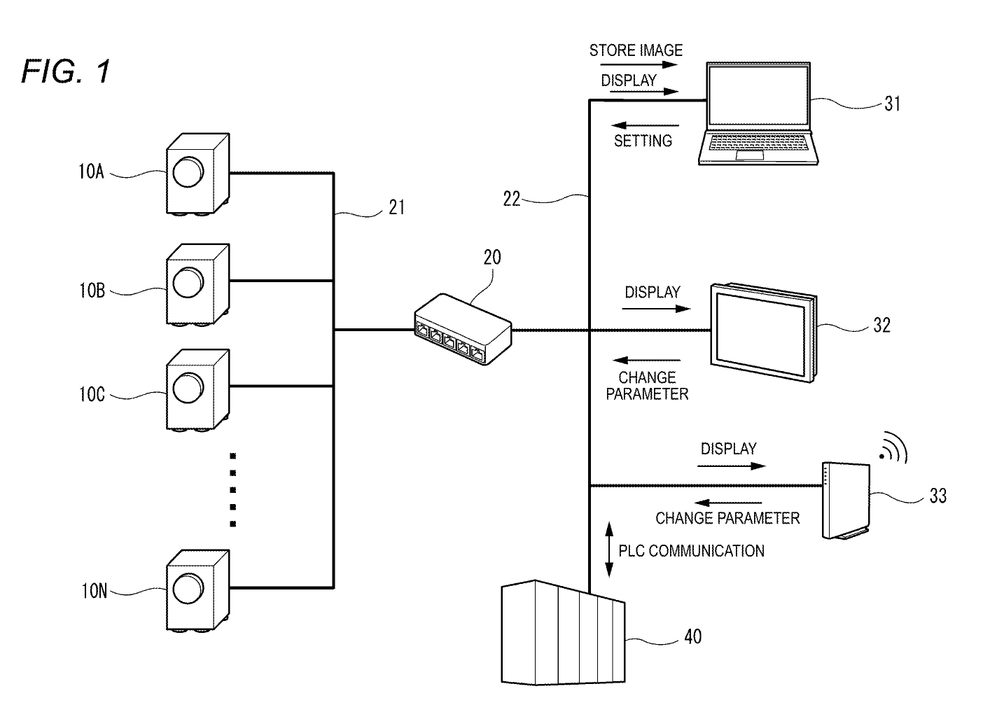

FIG. 1 is a diagram illustrating a configuration example of the image inspection system according to the present embodiment. The image inspection system includes a plurality of (for example, N) image inspection apparatuses 10A, 10B, 10C,□, and 10N. The plurality of image inspection apparatuses 10A to 10N may be representatively referred to as an image inspection apparatus 10. The image inspection apparatus 10 is also referred to as an image sensor, an image processing apparatus, or the like, and has a function of imaging a target and image processing and inspecting the captured image according to a predetermined image inspection program. The image inspection apparatuses 10A to 10N, which are connected to a wired or wireless network 21 as a communication interface, input and output various types of information such as image information, setting information, and inspection result information.

The image inspection apparatuses 10A to 10N are connected to another wired or wireless network 22 as a communication interface through a HUB 20. A personal computer (PC) 31, a monitor terminal 32, a wireless local area network (LAN) router 33, and a programmable logic controller (PLC) 40 are connected to the network 22.

The example illustrated in the drawing shows a configuration in which the networks 21 and 22 constituting the communication interface are connected to a network by a wired LAN such as Ethernet (registered trademark). Various wired or wireless networks and communication lines can be used as the communication interface as long as communication can be performed using a general-purpose protocol to be described later. Here, a configuration example in which the image inspection apparatuses 10A to 10N are connected to various terminals and devices such as the PC 31 and the monitor terminal 32 through the plurality of networks 21 and 22 is shown, but a connection state is not limited thereto. The image inspection apparatus 10 may be connected to a terminal or a device through a single network or may be directly connected to a terminal or a device.

The PC 31 includes a processor, a memory, a display device such as a display, and an input device such as a keyboard, and includes a processing unit having a function of operating an application such as a browser and an image inspection program preparation tool. The PC 31 performs processes such as setting the image inspection apparatus 10, displaying an inspection image acquired by the image inspection apparatus 10, and saving the inspection image. The inspection image acquired by the image inspection apparatus 10 includes not only image information of the captured image but also various types of inspection result information obtained through image processing. Instead of the PC 31, an information processing apparatus such as a tablet terminal and a smart phone which has a browser display function and a communication function may be connected and used.

The monitor terminal 32, which is a monitoring device used exclusively for an image inspection system or a monitoring device usable for other purposes, includes a display device such as a display, a memory, and an input device such as a touch panel and includes a processing unit which has a function of operating an application such as a browser. The monitor terminal 32 performs processes such as displaying the inspection image acquired by the image inspection apparatus 10 and changing parameters of the image inspection apparatus 10.

The browsers mounted on the PC 31 and the monitor terminal 32, which are also referred to as web browsers, access a predetermined uniform resource locator (URL) on an Internet protocol (IP) network, perform communication using a general-purpose protocol represented by HyperText transfer protocol (HTTP), and display contents (web contents) written in languages such as HyperText markup language (HTML) and extensible markup language (XML), The PC 31 and the monitor terminal 32 can access the image inspection apparatuses 10A to 10N by the browser, display the inspection image, set the image inspection apparatus, and change parameters regarding image inspection.

The wireless LAN router 33 functions as an access point of a wireless LAN and can be connected to various terminals such as a PC and a tablet terminal through a wireless network. The wireless LAN router 33 performs data transmission related to displaying the inspection image acquired by the image inspection apparatus 10, changing parameters of the image inspection apparatus 10, and the like.

The PLC 40 has a function of performing PLC communication through the networks 21 and 22 and performing sequence control on each device of the image inspection system. The image inspection apparatus 10 is operable according to predetermined sequence control such as starting image inspection by a control signal (trigger signal) of an inspection start instruction received from the PLC 40.

### Configuration Example of Image Inspection Apparatus

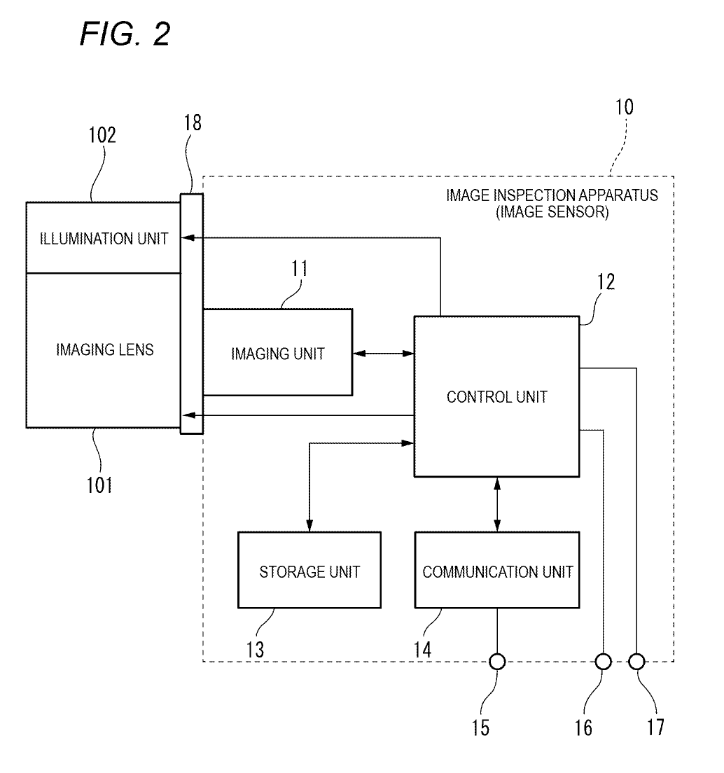

FIG. 2 is a block diagram illustrating a configuration example of the image inspection apparatus according to the present embodiment. The image inspection apparatus 10 includes an imaging unit 11, a control unit 12, a storage unit 13, and a communication unit 14. The image inspection apparatus 10 is configured to mount an imaging lens 101 and an illumination unit 102 on a lens mounting portion 18. The image inspection apparatus 10 is used for image inspection by mounting the imaging lens 101 having appropriate optical characteristics according to an installation location or an inspection target and also mounting the illumination unit 102 having appropriate lighting characteristics when necessary.

The imaging unit 11 includes a solid-state imaging element constituted by a charge coupled device (CCD) type image sensor, a complementary metal oxide semiconductor (CMOS) type image sensor, or the like. The imaging unit 11 captures an image of an inspection target which is a subject of which the image is formed by the imaging lens 101 under the control of the control unit 12 and outputs an imaging signal.

The control unit 12 includes a processor such as a CPU, and performs control process for controlling the overall operations of units of the image inspection apparatus 10, data input and output process between the image inspection apparatus 10 and an external terminal or device, data arithmetic operation (calculation) process, and data storage process. The storage unit 13 includes a memory such as a RAM or a ROM, and stores various information such as a firmware program for controlling the operation of the image inspection apparatus 10, a predetermined image inspection program for executing image inspection, setting data including various setting items and parameters regarding image inspection, image data of the captured image captured by the imaging unit 11, and inspection result data acquired through image inspection.

The control unit 12 processes an imaging signal of an inspection target of which the image is captured by the imaging unit 11 and outputs the processed imaging signal as the captured image that is a moving image or a still image. The control unit 12 processes the captured image and inspects an inspection item according to a predetermined image inspection program, and generates the inspection image including image information and inspection result information of the captured image. Meanwhile, a configuration may also be adopted in which a plurality of imaging units 11 are provided to be connected to the control unit 12 and are controlled by the control unit 12.

The control unit 12 has a function of a web server, and generates and outputs web contents for performing screen display of inspection image information including the inspection image for displaying the captured image, inspection results, and the like, image inspection-related information regarding image inspection, and the like, based on an access request using a general-purpose protocol such as HTTP from the PC 31 or the monitor terminal 32. The image inspection-related information includes inspection setting information including various setting items and parameters regarding image inspection and system setting information including various setting information of the image inspection system.

The control unit 12 executes processing based on predetermined authentication information regarding access from an external terminal or device such as the PC 31 or the monitor terminal 32. As the authentication information, character input information such as a password may be used. As the authentication information, identification information usable for various authentications through a network such as a bar code, a two-dimensional code, authentication key information using an encryption key, or an electronic certificate may be used. As the authentication information, device ID information for identifying a specific terminal or device such as a MAC address of the device, an IP address uniquely allocated to the device, a serial number of the device, or a terminal identification number may be used. As the authentication information, user ID information for identifying a specific user such as ID information like the user's ID card, face authentication information of the user, or biological authentication information such as a fingerprint, a vein pattern, and an iris pattern may be used.

The communication unit 14 including a network interface for connection to a network such as Ethernet (registered trademark) communicates with an external terminal or device connected thereto through the network and transmits authentication information, image information, setting information, inspection result information, and the like. The communication unit 14 communicates with the PC 31, the monitor terminal 32, and the like using a general-purpose protocol such as HTTP.

The communication unit 14 may include a wireless communication interface for connection to a wireless network such as a wireless LAN or a mobile communication network. The communication unit 14 may include a wireless communication interface for connection to an external terminal or device through near field communication such as Bluetooth (registered trademark).

The image inspection apparatus 10 includes a communication terminal 15, a power source and signal input terminal 16, and an illumination power source input terminal 17 as terminals for connection to the outside. The communication terminal 15, which is an input and output terminal for external communication, is connected to the communication unit 14 and is configured to include a connector for connecting to a network cable. The communication unit 14 is connected to the network 21 through the communication terminal 15. The power source and signal input terminal 16, which is an input terminal for inputting a power source and an external signal of the image inspection apparatus 10, is connected to the control unit 12 and is configured to include a connector for connecting to a signal cable. The power source of the image inspection apparatus 10 is supplied through the power source and signal input terminal 16. A control signal from the external PLC 40 or the like is input through the power source and signal input terminal 16. The illumination power source input terminal 17, which is an input terminal for inputting an illumination power source, is connected to the illumination unit 102 mounted outside through the control unit 12 and the lens mounting portion 18, and is configured to include a connector for connecting to a power source cable. The power source of the illumination unit 102 is supplied through the illumination power source input terminal 17.

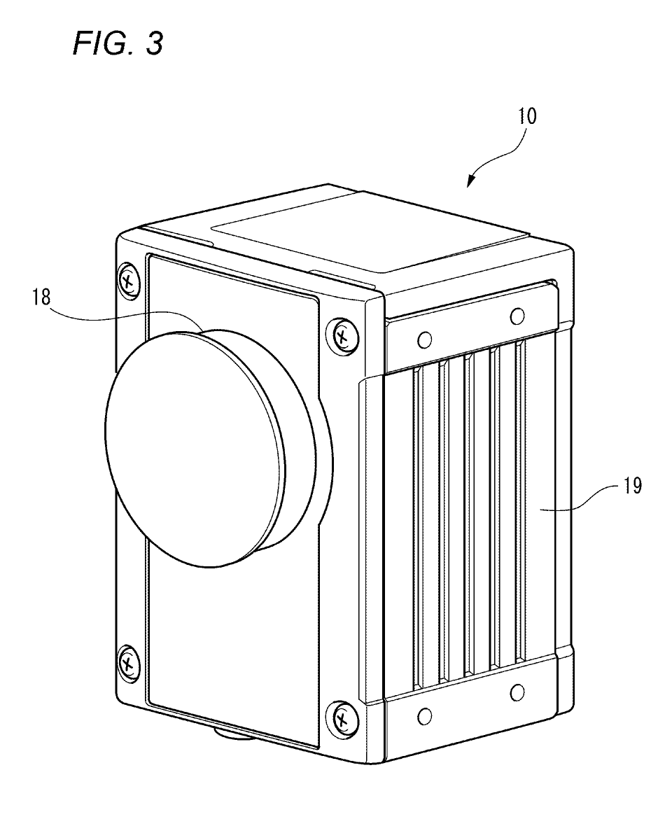

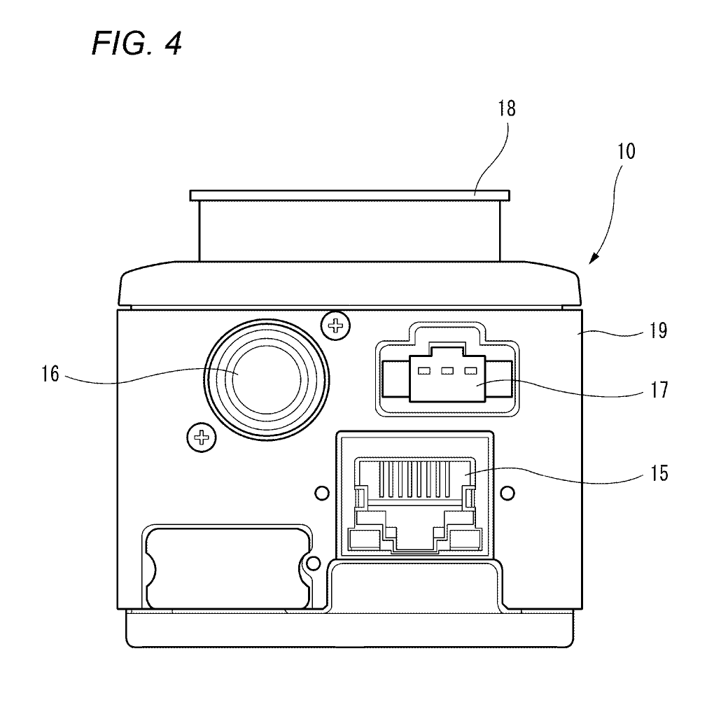

FIG. 3 is a perspective view illustrating an example of an exterior configuration of the image inspection apparatus according to the present embodiment, and FIG. 4 is a bottom view illustrating an example of an exterior configuration of the image inspection apparatus according to the present embodiment.

The image inspection apparatus 10 is configured to include a housing 19 having a substantially rectangular parallelepiped shape (box shape), and inside the housing 19, there is accommodated a substrate on which the control unit 12, the storage unit 13, and the communication unit 14 are mounted thereon. The lens mounting portion 18 is provided on one side surface of the housing 19, and the imaging unit 11 is disposed inside the lens mounting portion 18. The communication terminal 15, the power source and signal input terminal 16, and the illumination power source input terminal 17 are disposed on the bottom surface of the housing 19.

### First Example of Connection Configuration of Image Inspection System

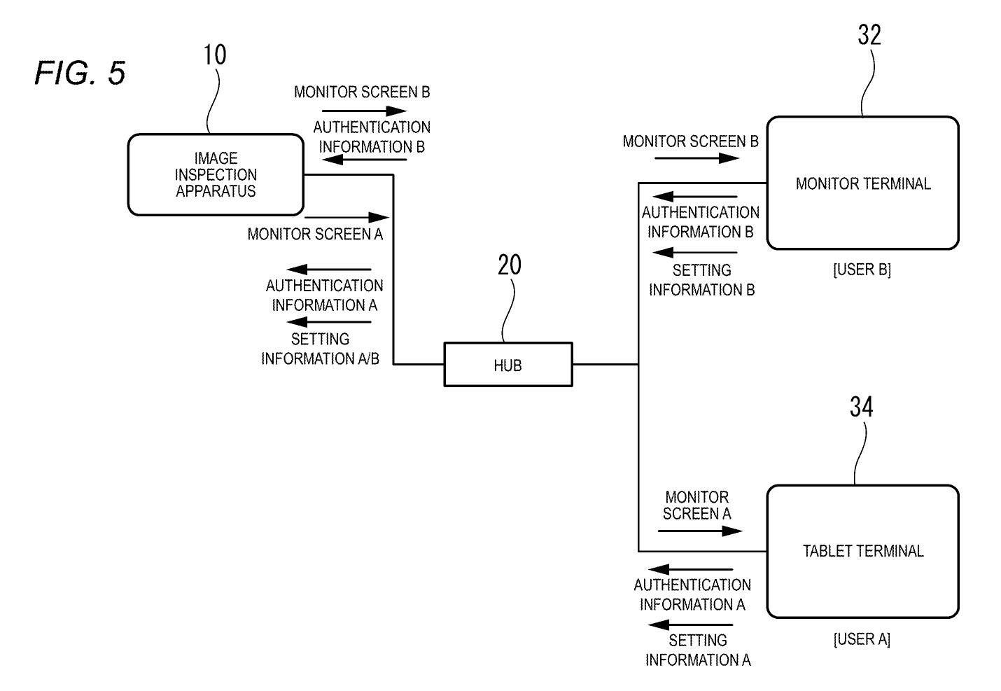

FIG. 5 is a block diagram illustrating a first example of a connection configuration of the image inspection system according to the present embodiment. The first example shows an example in which a plurality of terminals are connected to the image inspection apparatus 10. The monitor terminal 32 and a tablet terminal 34 are connected to the image inspection apparatus 10 as an image sensor through the network 21, the HUB 20, and the network 22. In the present example, it is assumed that a user A using the tablet terminal 34 has an administrative right and a user B using the monitor terminal 32 has a public user right.

The tablet terminal 34 transmits password information to the image inspection apparatus 10 as authentication information A. In this case, the tablet terminal 34 displays a password input screen such as a login screen, receives a password input by a user's operation, and transmits the input password information. The image inspection apparatus 10 receives the authentication information A from the tablet terminal 34 to authenticate the user A accessed using the tablet terminal 34. The tablet terminal 34 may be authenticated by the authentication information A. When the image inspection apparatus 10 determines permission of access as a result of the authentication, the image inspection apparatus 10 transmits a monitor screen A associated with the authentication information A to the tablet terminal 34. That is, the image inspection apparatus 10 transmits the monitor screen A corresponding to the user A or the tablet terminal 34 to the tablet terminal 34. Here, it is assumed that the monitor screen A includes an inspection image screen displaying inspection image information obtained by the image inspection apparatus 10, an inspection setting screen on which the display and input of inspection setting information regarding image inspection can be performed, and a system setting screen on which the display and input of system setting information of the image inspection system can be performed. In the initial state, an inspection image screen for the user A is displayed on the tablet terminal 34 as the monitor screen A.

The monitor terminal 32 transmits password information to the image inspection apparatus 10 as authentication information B. In this case, the monitor terminal 32 displays a password input screen such as a login screen, receives an input of a password by a user's operation, and transmits the input password information. The image inspection apparatus 10 receives the authentication information B from the monitor terminal 32 to authenticate the user B accessed using the monitor terminal 32. The monitor terminal 32 itself may be authenticated by the authentication information B. When the image inspection apparatus 10 determines permission of access as a result of the authentication, the image inspection apparatus 10 transmits a monitor screen B associated with the authentication information B to the monitor terminal 32. That is, the image inspection apparatus 10 transmits the monitor screen B corresponding to the user B or the monitor terminal 32 to the monitor terminal 32. Here, it is assumed that the monitor screen B includes an inspection image screen for displaying inspection image information obtained by the image inspection apparatus 10 and an inspection setting screen on which the display and input of inspection setting information regarding image inspection can be performed. In the initial state, an inspection image screen for the user B is displayed on the monitor terminal 32 as the monitor screen B.

The tablet terminal 34 and the monitor terminal 32 access the image inspection apparatus 10 using a general-purpose protocol such as HTTP through a browser, and the image inspection apparatus 10 distributes the monitor screen A and the monitor screen B to the respective terminals as web contents.

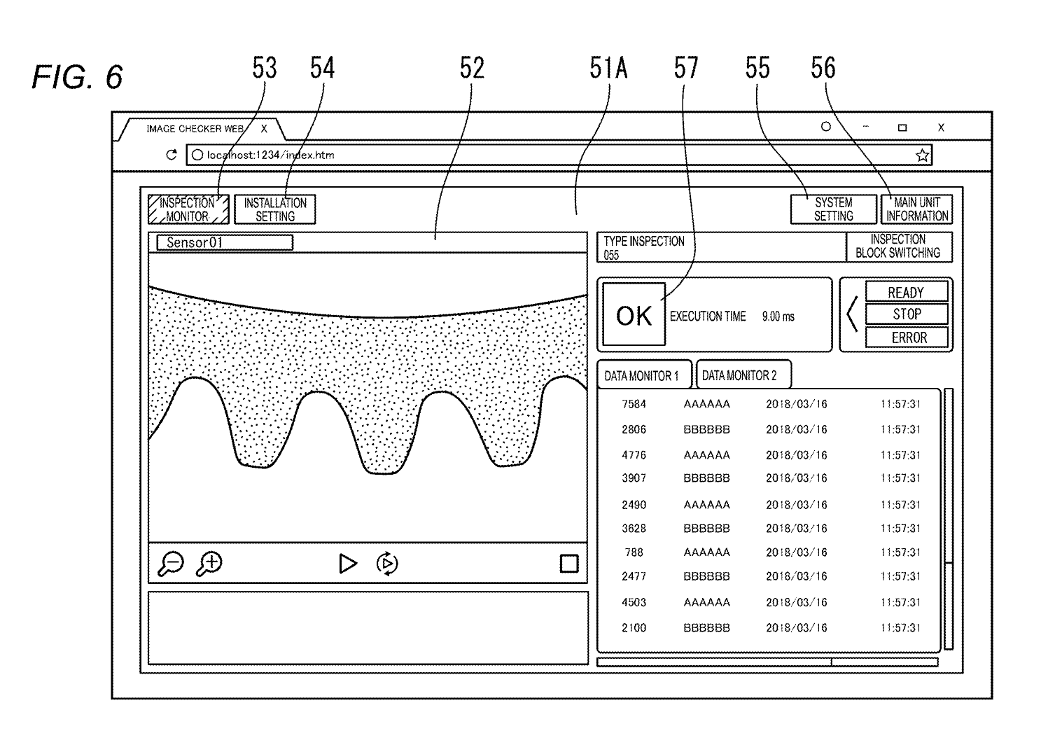

FIG. 6 is a diagram illustrating a first example of an inspection image screen in the image inspection system according to the present embodiment. The first example shows an example of an inspection image screen 51A corresponding to the above-described monitor screen A displayed on the tablet terminal 34. FIG. 6 illustrates a state where the inspection image screen 51A including an inspection image is displayed on the monitor screen A. The inspection image screen 51A is displayed on a display unit by the browser of the tablet terminal 34.

A captured image 52 captured by a first image inspection apparatus 10A (Sensor01) is displayed on the inspection image screen 51A. Regarding the captured image 52, it is possible to display various forms such as a real time captured image showing the current state of the target and a post- inspection captured image including an index of image inspection, and the like. A result display 57 indicating an inspection result is displayed beside the captured image 52. In the example illustrated in the drawing, the state of “OK” indicating a good inspection result is displayed in the result display 57. Inspection data acquired in image inspection such as a data monitor 1 and a data monitor 2 is displayed below the result display 57.

An inspection monitor button 53, an installation setting button 54, a system setting button 55, and a main unit information button 56 are provided in the upper portion of the inspection image screen 51A. When the user operates the inspection monitor button 53, the inspection image screen 51A including the captured image 52 and the result display 57 is displayed. When the user operates the installation setting button 54, an inspection setting screen as will be described later is displayed. When the user operates the system setting button 55, a system setting screen as will be described later is displayed. When the user operates the main unit information button 56, main unit information of the first image inspection apparatus 10A is displayed.

A list of thumbnail images indicating inspection images acquired in the image inspection apparatus 10 in the past may be displayed so that the inspection images can be retroactively and collectively confirmed. A captured image of the corresponding inspection image and inspection results may be displayed in detail by designating a specific thumbnail image. A quality determination result of image inspection associated with the thumbnail image may be displayed.

When the user A performs a setting operation regarding image inspection in the tablet terminal 34, the tablet terminal 34 transmits a request for displaying an inspection setting screen to the image inspection apparatus 10 according to an operation of the user A. When the image inspection apparatus 10 receives the request for displaying an inspection setting screen from the tablet terminal 34, the image inspection apparatus 10 transmits an inspection setting screen corresponding to the user A or the tablet terminal 34 to the tablet terminal 34. Similarly, when the user A performs a setting operation for the image inspection system in the tablet terminal 34, the image inspection apparatus 10 transmits a system setting screen corresponding to the user A or the tablet terminal 34 to the tablet terminal 34.

In this manner, an inspection setting screen or a system setting screen for the user A is displayed on the tablet terminal 34. When the user A performs an operation for the inspection setting screen or an operation for the system setting screen in the tablet terminal 34, the tablet terminal 34 transmits setting information A corresponding to the operation of the user A to the image inspection apparatus 10. The image inspection apparatus 10 receives the setting information A from the tablet terminal 34 and performs setting process such as changing various setting regarding image inspection or various setting of the image inspection system.

When the user B performs a setting operation regarding image inspection in the monitor terminal 32, the monitor terminal 32 transmits a request for displaying an inspection setting screen to the image inspection apparatus 10 according to an operation of the user B. When the image inspection apparatus 10 receives the request for displaying an inspection setting screen from the monitor terminal 32, the image inspection apparatus 10 transmits an inspection setting screen corresponding to the user B or the monitor terminal 32 to the monitor terminal 32. Thereby, the inspection setting screen for the user B is displayed on the monitor terminal 32. When the user B performs an operation for the inspection setting screen in the monitor terminal 32, the monitor terminal 32 transmits setting information B corresponding to the operation of the user B to the image inspection apparatus 10. The image inspection apparatus 10 receives the setting information B from the monitor terminal 32 and performs setting process such as changing various setting regarding image inspection.

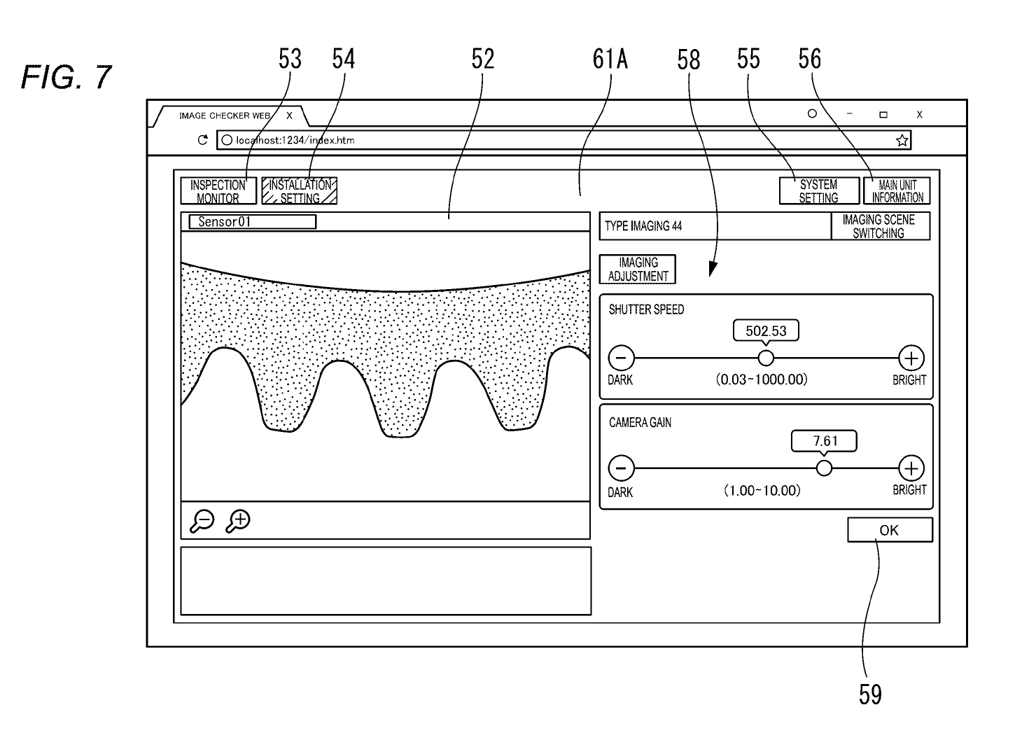

FIG. 7 is a diagram illustrating an example of an inspection setting screen in the image inspection system according to the present embodiment. The example illustrated in the drawing shows an example of an inspection setting screen for performing camera setting of the image inspection apparatus 10. When the user operates the installation setting button 54 of the inspection image screen 51A illustrated in FIG. 6, a browser display screen of the tablet terminal 34 is set to display an inspection setting screen 61A including inspection setting display.

An inspection setting display 58 is displayed beside the captured image 52 on the inspection setting screen 61A. In the example illustrated in the drawing, a setting image for setting a shutter speed and a camera gain related to the camera setting of the image inspection apparatus 10 is displayed as the inspection setting display 58. When the user operates items such as a switch and a slide bar of the inspection setting display 58, inputs a setting value, and operates an OK button 59, inspection setting information including various setting items and parameters regarding image inspection is transmitted to the image inspection apparatus 10 as setting information A. The image inspection apparatus 10 receives the setting information A including the inspection setting information from the tablet terminal 34 and performs setting process of image inspection. In the example illustrated in the drawing, the camera setting of the imaging unit 11, that is, the setting of the shutter speed and the camera gain is performed.

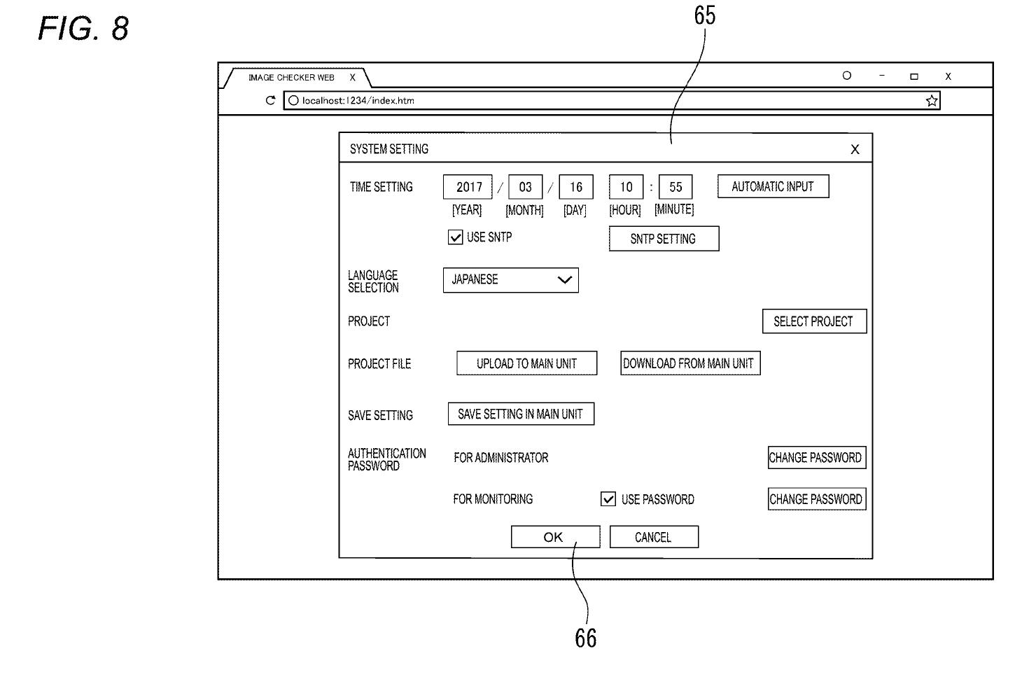

FIG. 8 is a diagram illustrating an example of a system setting screen in the image inspection system according to the present embodiment. The example illustrated in the drawing shows an example of a system setting screen for setting an authentication password and the like of the image inspection system. When the user operates the system setting button 55 of the inspection image screen 51A illustrated in FIG. 6, the browser display screen of the tablet terminal 34 is set to display a system setting screen 65. A setting image for setting time setting, language selection, save setting, an authentication password, and the like related to the image inspection system is displayed on the system setting screen 65. When the user performs an input operation on the system setting screen 65 and operates an OK button 66, system setting information regarding the image inspection system is transmitted to the image inspection apparatus 10 as setting information A. The image inspection apparatus 10 receives the setting information A including the system setting information from the tablet terminal 34 and performs setting process for the image inspection system.

In this case, the image inspection apparatus 10 transmits different contents according to access authority or setting for each user between the monitor screen A to be distributed to the tablet terminal 34 and the monitor screen B to be distributed to the monitor terminal 32. For example, detailed inspection results are displayed on an inspection image screen for an administrator of the monitor screen A, and simple inspection results are displayed on an inspection image screen for public users of the monitor screen B. For example, detailed setting items regarding image inspection are displayed on the inspection setting screen for the administrator of the monitor screen A, and simple setting items such as parameters of a camera are displayed on the inspection setting screen for public users of the monitor screen B. A system setting screen is displayed on the monitor screen A, and a system setting screen is not displayed on the monitor screen B. The image inspection apparatus 10 in the initial state may transmit a monitor screen for a guest user to a terminal before the completion of authentication.

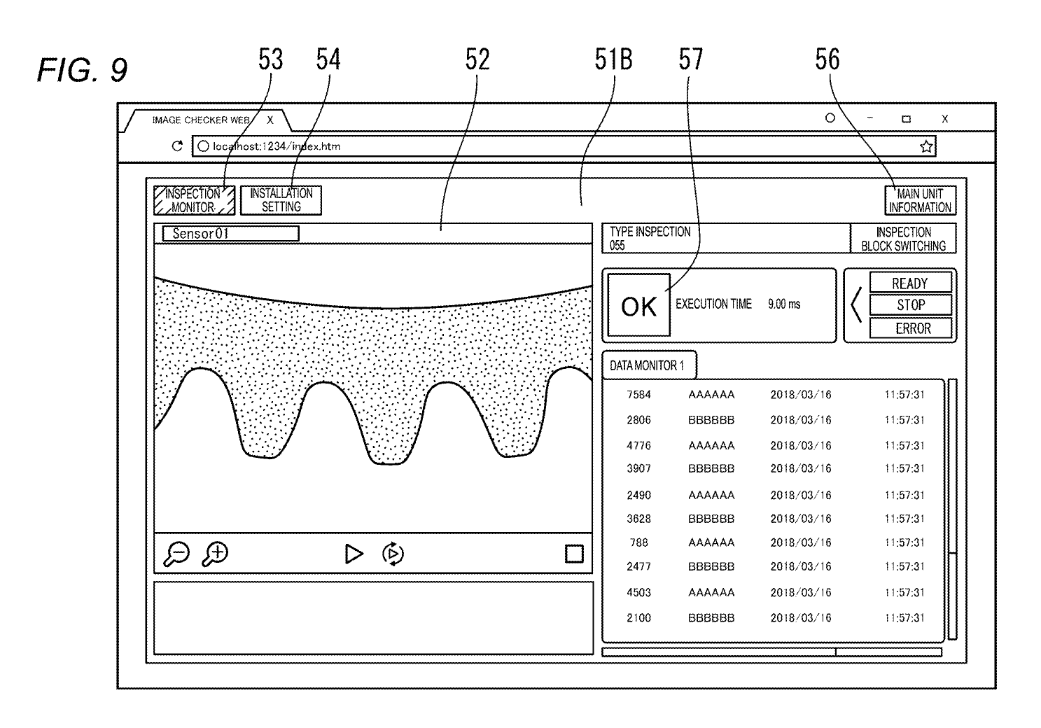

FIG. 9 is a diagram illustrating a second example of an inspection image screen in the image inspection system according to the present embodiment. The second example shows an example of an inspection image screen 51B corresponding to the above-described monitor screen B displayed on the monitor terminal 32. FIG. 9 illustrates a state where the inspection image screen 51B including an inspection image is displayed on the monitor screen B. The inspection image screen 51B is displayed on the display unit by the browser of the monitor terminal 32.

Similarly to the inspection image screen 51A of the tablet terminal 34, a captured image 52 and a result display 57 are displayed on the inspection image screen 51B of the monitor terminal 32. In the inspection image screen 51B, a simple result display for public users is performed such that only a data monitor 1 is displayed in the result display 57 without a data monitor 2. In the inspection image screen 51B, the system setting button 55 is not displayed, such that a system setting screen cannot be displayed.

In the inspection image screen 51B, when the user operates the installation setting button 54, a browser display screen of the monitor terminal 32 is set to display an inspection setting screen which is the same as the inspection setting screen 61A of the tablet terminal 34. When the user performs an input operation on the inspection setting screen, inspection setting information including various parameters regarding image inspection is transmitted to the image inspection apparatus 10 as setting information B. The image inspection apparatus 10 receives the setting information B including the inspection setting information from the monitor terminal 32 and performs setting process of image inspection.

If the image inspection apparatus 10 receives the setting information A from the tablet terminal 34 and the setting information B from the monitor terminal 32 simultaneously, the image inspection apparatus 10 performs exclusive control, receives the inspection setting information from one of the terminals, and prohibits a simultaneous setting input from the other terminal. Regarding the display of the inspection setting screen and/or the system setting screen, the image inspection apparatus 10 may perform authentication using authentication information such as a password when a request for displaying a setting screen is received from the terminal, and may transmit and display information on the setting screen after authentication is permitted. The image inspection apparatus 10 may store a history of setting process related to various setting in the storage unit 13 using log information or the like, when the image inspection apparatus 10 receives the setting information from the tablet terminal 34 and the monitor terminal 32 and performs setting process. The image inspection apparatus 10 may display history information of the setting process related to various setting on the inspection setting screen or the system setting screen. The image inspection apparatus 10 may display the current setting conditions on the inspection setting screen or the system setting screen regarding inspection setting information related to various setting of image inspection or system setting information related to various setting of the image inspection system.

The image inspection apparatus 10 may update and distribute an inspection image in real time regarding an inspection image screen of web contents to be transmitted to the terminal in a web server function of the control unit 12. For example, at least one among captured images of the inspection image and inspection results is updated at intervals of several tens of milliseconds to several seconds to generate a monitor screen for updating the inspection image screen in real time. Alternatively, the inspection image may be constantly updated and generated at predetermined time intervals including real time, such as the update of the captured image and/or inspection results every several minutes. Thereby, display contents of the inspection image are automatically updated without the need for the user to operate the terminal in the inspection image screen 51A of the tablet terminal 34 and the inspection image screen 51B of the monitor terminal 32. In the inspection image screen 51A and the inspection image screen 51B, an update button may be provided within each of the screens so that an inspection image is updatable at all times by the user's update operation. In the inspection image screen 51A and the inspection image screen 51B, a stop button may be provided within each of the screens so that display contents of the inspection image screen can be stopped by the user's stop operation. In this case, when the user operates the stop button, update of the inspection image screen stops, and the display contents of the inspection image screen at the point in time are continuously displayed. For example, if a determination result for inspection results is NG, the user can stop the inspection image screen to confirm details thereof

In this manner, the image inspection apparatus 10 transmits monitor screens for each user account or monitor screens for each terminal to each of a plurality of terminals to be connected and causes the terminal to display the respective monitor screens. In this case, the image inspection apparatus 10 identifies a user or a terminal based on authentication information such as a password and transmits the monitor screen individually corresponding to the user or the terminal. The image inspection apparatus 10 transmits and displays a monitor screen including a setting screen for each user account or each terminal in response to requests for setting screens from the plurality of terminals. The image inspection apparatus 10 receives setting information from the plurality of terminals and performs setting process of various setting regarding image inspection or various setting of the image inspection system.

According to the present embodiment, it is possible to distribute monitor screens such as inspection image screens as web contents from the image inspection apparatus to a terminal through communication of a general-purpose protocol and to display the monitor screens on a browser screen of the terminal. Therefore, a user may access the image inspection apparatus from a terminal positioned at a desired location through a network, acquire and display an inspection image screen and an inspection setting screen, and easily perform monitoring of an inspection image at any location, setting regarding image inspection through a remote operation, and the like. It is not necessary to use a dedicated monitor and dedicated software, and the introduction cost of the image inspection system can be reduced.

Since an inspection image screen and an inspection setting screen can be acquired by accessing the image inspection apparatus from a plurality of terminals, it is possible to perform monitoring of an inspection image from a plurality of locations and setting regarding image inspection of one image inspection apparatus. If setting regarding image inspection is performed from a plurality of terminals, exclusive control is performed to prevent discrepancies during setting and to reduce a problem of unintended setting. It is possible to distribute an inspection image screen and an inspection setting screen which are different for each user or each terminal by authenticating a user or a terminal based on authentication information such as a password. Therefore, it is possible to execute monitoring of an inspection image according to access authority which is set for each user or each terminal and setting regarding image inspection.

### Second Example of Connection Configuration of Image Inspection System

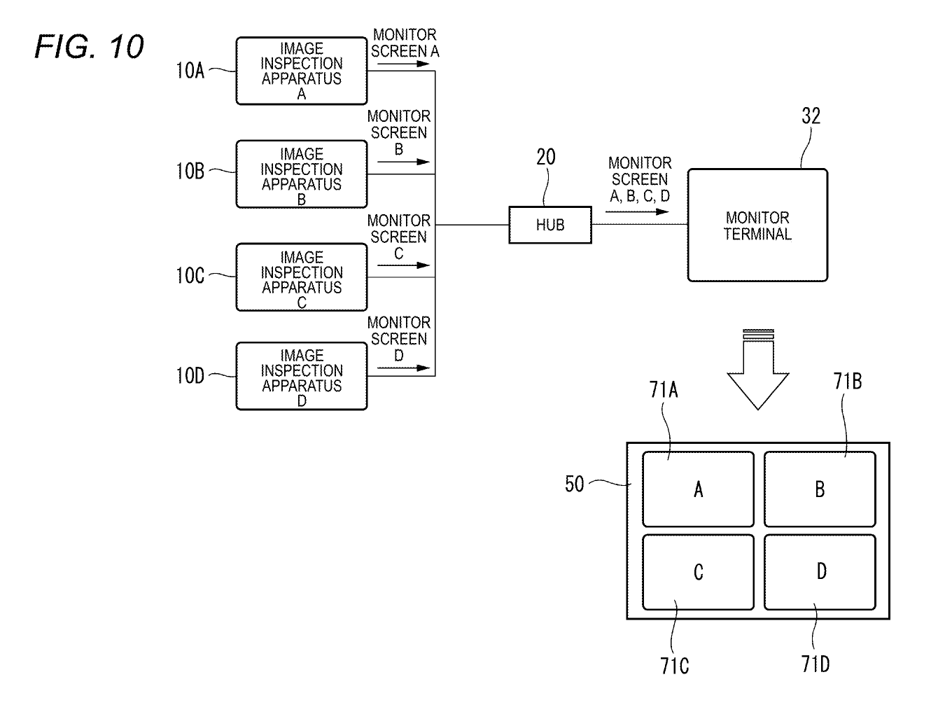

FIG. 10 is a block diagram illustrating a second example of the connection configuration of the image inspection system according to the present embodiment. The second example shows an example in which a plurality of image inspection apparatuses 10 are connected to a terminal. Image inspection apparatuses 10A to 10D as a plurality of (four in the example illustrated in the drawing) image sensors are connected to the monitor terminal 32 through the network 21, the HUB 20, and the network 22. The monitor terminal 32 accesses the image inspection apparatuses 10A to 10D using a general-purpose protocol such as HTTP by the browser. The first image inspection apparatus (image inspection apparatus A) 10A distributes a monitor screen A to the monitor terminal 32 as web contents. The second image inspection apparatus (image inspection apparatus B) 10B distributes a monitor screen B to the monitor terminal 32 as web contents. The third image inspection apparatus (image inspection apparatus C) 10C distributes a monitor screen C to the monitor terminal 32 as web contents. The fourth image inspection apparatus (image inspection apparatus D) 10D distributes a monitor screen D to the monitor terminal 32 as web contents.

An inspection image screen is displayed on a display screen 50 of the monitor terminal 32 by the browser of the monitor terminal 32, similar to the first example. The monitor terminal 32 displays an inspection image screen 71A of the monitor screen A, an inspection image screen 71B of the monitor screen B, an inspection image screen 71C of the monitor screen C, and an inspection image screen 71D of the monitor screen D as a plurality of inspection image screens acquired by the image inspection apparatuses 10A to 10D.

The monitor screens A to D are respectively distributed by the image inspection apparatuses 10A to 10D, and thus it is possible to simultaneously display the inspection image screens 71A, 71B, 71C, and 71D acquired by the plurality of image inspection apparatuses 10A to 10D on one screen in a screen division manner in the monitor terminal 32. Since the inspection image screens 71A to 71D are displayed by the browser, it is possible to freely set layouts of the plurality of monitor screens such as sizes, arrangement, and superimposition of the monitor screen.

According to the present embodiment, it is possible to distribute monitor screens such as inspection image screens as web contents from the plurality of image inspection apparatuses to a terminal through communication of a general-purpose protocol and to display the monitor screens on a browser screen of the terminal. Therefore, a user can simultaneously display the monitor screens from the plurality of image inspection apparatuses in a screen division manner or the like and can perform monitoring of a plurality of inspection images, and the like at one location. Regarding the monitor screens such as a plurality of inspection image screens, it is possible to flexibly set and change the arrangement of the screens in the terminal and to improve the visibility of the user.

As described above, the image inspection apparatus 10 according to the present embodiment includes an imaging unit 11 configured to capture an image of an inspection target, a control unit 12 configured to process the captured image of the inspection target and executes predetermined image inspection, and a communication unit 14 configured to communicate with a terminal about information that is input to and output from the control unit 12, and the communication unit 14 is configured to be capable of performing communication using a general-purpose protocol. The control unit 12 has a web server function of distributing web contents in response to access requests from terminals 31, 32, and 34 connected to the apparatus, acquires authentication information transmitted from the terminals 31, 32, and 34, authenticates a user or a terminal based on the authentication information, receives access requests for monitor screens regarding image inspection from the terminals 31, 32, and 34 using a general-purpose protocol, generates web contents of a dedicated monitor screen corresponding to the authenticated user or terminal, and transmits the generated web contents to the terminals 31, 32, and 34.

Thereby, in the terminals 31, 32, and 34 connected to the image inspection apparatus 10, monitor screens such as an inspection image screen and an inspection setting screen can be acquired and displayed on a browser screen, and a user can easily perform monitoring of an inspection image, setting regarding image inspection through a remote operation, and the like by accessing the image inspection apparatus from a terminal positioned at a desired location. It is possible to distribute an inspection image screen and an inspection setting screen which are different for each user or each terminal by authenticating a user or a terminal based on authentication information and to display individual monitor screens corresponding to the user or the terminal in each of the terminals 31, 32, and 34. Therefore, it is possible to easily execute monitoring of an inspection image and setting according to usage conditions of the user in the image inspection system without using a dedicated monitor and dedicated software.

In the image inspection apparatus 10, the control unit 12 generates, as a monitor screen to be distributed to a terminal, an inspection image screen for displaying inspection image information including captured images and inspection results in image inspection. Thereby, in a terminal connected to the image inspection apparatus 10, it is possible to display the inspection image screen corresponding to the user or the terminal, and the user can easily monitor a desired inspection image.

In the image inspection apparatus 10, the control unit 12 constantly updates and generates an inspection image screen at predetermined time intervals. Thereby, it is possible to distribute a monitor screen of an inspection image screen in which contents of an inspection image are automatically and constantly updated without particularly performing an update operation and the like in a terminal, and a user can confirm the update operation.

In the image inspection apparatus 10, the control unit 12 generates, as a monitor screen to be distributed to a terminal, an inspection setting screen on which the display and input of inspection setting information regarding image inspection can be performed. Thereby, in a terminal connected to the image inspection apparatus 10, an inspection setting screen corresponding to the user or the terminal can be displayed, and the user can easily execute various setting regarding image inspection.

In the image inspection apparatus 10, the control unit 12 generates, as a monitor screen to be distributed to the terminal, a system setting screen on which the display and input of system setting information regarding the image inspection system including the image inspection apparatus and a terminal can be performed. Thereby, in a terminal connected to the image inspection apparatus 10, a system setting screen corresponding to the user or the terminal can be displayed, and the user can easily execute various setting related to the image inspection system.

In the image inspection apparatus 10, the control unit 12 acquires password information as authentication information from a terminal and authenticates the acquired password information to generate a dedicated monitor screen corresponding to the authenticated user or terminal. Thereby, in a terminal connected to the image inspection apparatus 10, it is possible to display a monitor screen such as a dedicated inspection image screen for each user or each terminal and to execute monitoring of an inspection image and setting according to a purpose in each terminal.

The image inspection system according to the present embodiment is an image inspection system including the image inspection apparatus 10 configured to capture an image of an inspection target and execute image processing and predetermined image inspection of the captured image and the terminals 31, 32, and 34 that are connected to the image inspection apparatus 10 through a communication interface. The image inspection apparatus 10 includes the imaging unit 11 configured to capture the image of the inspection target, the control unit 12 configured to process the captured image of the inspection target and execute the predetermined image inspection, and the communication unit 14 configured to communicate with the terminals 31, 32, and 34 about information that is input to and output from the control unit 12, and the communication unit 14 is configured to be capable of performing communication using a general-purpose protocol. The control unit 12 has a web server function of distributing web contents in response to access requests from the terminals 31, 32, and 34, acquires authentication information transmitted from the terminals 31, 32, and 34, authenticates a user or a terminal based on the authentication information, receives access requests for a monitor screen regarding image inspection from the terminals 31, 32, and 34 using a general-purpose protocol, generates web contents of a monitor screen corresponding to the authenticated user or terminal, and transmits the generated web contents to the terminals 31, 32, and 34. Each of the terminals 31, 32, and 34 includes a display device and a processing unit having a browser function for displaying web contents distributed from the image inspection apparatus, transmits the authentication information to the image inspection apparatus 10, receives web contents of a monitor screen distributed to the terminal based on the authentication information, and displays a monitor screen regarding image inspection on the display device.

In the image inspection system according to the present embodiment, the image inspection apparatus 10, which is connected to the plurality of terminals 32 and 34, generates, as the monitor screen, an inspection image screen for displaying inspection image information including the captured image and an inspection result in image inspection, generates web contents of a monitor screen for the first terminal 34 in response to authentication information and an access request from the first terminal 34, transmits the generated web contents to the first terminal 34, generates a web content of a monitor screen for the second terminal 32 in response to authentication information and an access request from the second terminal 32, and transmits the generated web contents to the second terminal 32. Thereby, in the terminals 32 and 34 positioned at a plurality of locations, an inspection image screen can be acquired and displayed on a browser screen, and it is possible to easily perform monitoring of an inspection image by accessing the image inspection apparatus from a plurality of locations. In each of the first terminal 34 and the second terminal 32, it is possible to display a dedicated inspection image screen and to execute monitoring of an inspection image according to a purpose in each terminal.

In the image inspection system according to the present embodiment, the image inspection apparatus 10 generates, as a monitor screen, an inspection setting screen on which the display and input of inspection setting information regarding image inspection can be performed, and receives inspection setting information from one of the first terminal 34 and the second terminal 32 by performing exclusive control if inspection setting information from the first terminal 34 and inspection setting information from the second terminal 32 are received simultaneously. Thereby, in the terminals 32 and 34 positioned at a plurality of locations, an inspection image screen can be acquired and displayed on a browser screen, and it is possible to easily perform setting related to image inspection through a remote operation by accessing the image inspection apparatus from a plurality of locations. In each of the first terminal 34 and the second terminal 32, it is possible to display a dedicated inspection setting screen and to execute setting related to image inspection according to a purpose in each terminal. Exclusive control is performed, and thus it is possible to reduce a problem of unintended setting if pieces of setting information from a plurality of terminals conflict with each other.

In the image inspection system according to the present embodiment, the terminal 32, which is connected to the plurality of image inspection apparatuses 10A to 10D, transmits the authentication information and the access request to the first image inspection apparatus 10A to receive web contents of a first monitor screen regarding image inspection from the first image inspection apparatus 10A, transmits the authentication information and the access request to the second image inspection apparatuses 10B, 10C, and 10D to receive web contents of a second monitor screen regarding image inspection from the second image inspection apparatuses 10B, 10C, and 10D, and displays a plurality of monitor screens including the first monitor screen and the second monitor screen on a display device using a browser function. Thereby, it is possible to simultaneously display the monitor screens from the plurality of image inspection apparatuses in one terminal in a screen division manner or the like, and a user can perform monitoring of a plurality of inspection images, and the like at one location. Regarding the monitor screens such as the plurality of inspection image screens 71A to 71D, it is possible to flexibly set and change the arrangement of the screens in the terminal 32 and to improve the visibility of the user.

While various embodiments have been described with reference to the accompanying drawings, it is needless to say that the present invention is not limited to such examples. It would be apparent for those skilled in the art to which the invention belongs that various modified examples or corrected examples are conceivable within the scope recited in the claims, and it would be understood that these fall within the technical scope of the invention. The components in the above-described embodiments may be arbitrarily combined with each other without departing from the scope of the invention.

One or more embodiments of the present invention are useful as an image inspection apparatus and an image inspection system capable of executing monitoring of an inspection image and setting according to usage conditions without using a dedicated monitor and dedicated software.

1. An image inspection apparatus comprising:
an imaging unit configured to capture an image of an inspection target;
a control unit configured to process the captured image of the inspection target and execute predetermined image inspection; and
a communication unit configured to communicate with a terminal about information that is input to and output from the control unit,
wherein the communication unit is capable of performing communication using a general-purpose protocol, and
wherein the control unit has a web server function of distributing a web content in response to an access request from a terminal connected to the apparatus, acquires authentication information transmitted from the terminal to authenticate a user or a terminal based on the authentication information, receives an access request for a monitor screen regarding the image inspection from the terminal using the general-purpose protocol, generates a web content of a monitor screen corresponding to the authenticated user or terminal, and transmits the generated web content to the terminal.

2. The image inspection apparatus according to claim 1,
wherein the control unit generates, as the monitor screen, an inspection image screen for displaying inspection image information comprising the captured image and an inspection result in the image inspection.

3. The image inspection apparatus according to claim 2,
wherein the control unit constantly updates and generates the inspection image screen at predetermined time intervals.

4. The image inspection apparatus according to claim 1,
wherein the control unit generates, as the monitor screen, an inspection setting screen on which display and input of inspection setting information regarding the image inspection are capable of being performed.

5. The image inspection apparatus according to claim 1,
wherein the control unit generates, as the monitor screen, a system setting screen on which display and input of system setting information regarding an image inspection system comprising the image inspection apparatus and the terminal are capable of being performed.

6. The image inspection apparatus according to claim 1,
wherein the control unit acquires password information from the terminal as the authentication information to perform authentication and generates a dedicated monitor screen corresponding to the authenticated user or terminal.

7. An image inspection system comprising:
an image inspection apparatus configured to capture an image of an inspection target and execute image processing and predetermined image inspection of the captured image; and
a terminal that is connected to the image inspection apparatus through a communication interface,
wherein the image inspection apparatus comprises:
an imaging unit configured to capture the image of the inspection target;
a control unit configured to process the captured image of the inspection target and execute the predetermined image inspection; and
a communication unit configured to communicate with a terminal about information that is input to and output from the control unit,
wherein the communication unit is capable of performing communication using a general-purpose protocol,
wherein the control unit has a web server function of distributing a web content in response to an access request from the terminal, acquires authentication information transmitted from the terminal to authenticate a user or a terminal based on the authentication information, receives an access request for a monitor screen regarding the image inspection from the terminal using the general-purpose protocol, generates a web content of a monitor screen corresponding to the authenticated user or terminal, and transmits the generated web content to the terminal,
wherein the terminal comprises a display device and a processing unit having a browser function for displaying the web content distributed from the image inspection apparatus, and
wherein the terminal transmits the authentication information to the image inspection apparatus, receives the web content of the monitor screen distributed to the terminal based on the authentication information, and displays the monitor screen regarding the image inspection on the display device.

8. The image inspection system according to claim 7,
wherein the image inspection apparatus is connected to a plurality of terminals comprising a first terminal and a second terminal, generates, as the monitor screen, an inspection image screen for displaying inspection image information including the captured image and an inspection result in the image inspection, generates a web content of a monitor screen for the first terminal in response to authentication information and an access request from the first terminal, transmits the generated web content to the first terminal, generates a web content of a monitor screen for the second terminal in response to authentication information and an access request from the second terminal, and transmits the generated web content to the second terminal.

9. The image inspection system according to claim 8,
wherein the image inspection apparatus generates, as the monitor screen, an inspection setting screen on which display and input of inspection setting information regarding the image inspection are capable of being performed, and receives inspection setting information from one of the first terminal and the second terminal by performing exclusive control if inspection setting information from the first terminal and inspection setting information from the second terminal are received simultaneously.

10. The image inspection system according to claim 7,
wherein the terminal is connected to a plurality of image inspection apparatuses comprising a first image inspection apparatus and a second image inspection apparatus, transmits the authentication information and the access request to the first image inspection apparatus, receives a web content of a first monitor screen regarding image inspection from the first image inspection apparatus, transmits the authentication information and the access request to the second image inspection apparatus, receives a web content of a second monitor screen regarding image inspection from the second image inspection apparatus, and displays a plurality of monitor screens including the first monitor screen and the second monitor screen on the display device by the browser function.
